(19) United States
(12) Patent Application Publication
(10) Pub. No.: US 2010/0315509 A1
(43) Pub. Date: Dec. 16, 2010

(54) SYSTEM AND METHOD FOR MONITORING THE ACTIVITY OF A PERSON IN A COMPOUND, AND SENSOR FOR DETECTING A PERSON IN A PREDEFINED AREA

(76) Inventors: Jose Juan Blanch Puig, Barcelona (ES); Jose Bordonau Farrerons, Barcelona (ES)

Correspondence Address: ROBERTS MLOTKOWSKI SAFRAN & COLE, P.C.;Intellectual Property Department, P.O. Box 10064, MCLEAN, VA, 22102-8064, US

(21) Appl. No.: 12/867,397

(22) PCT Filed: Feb. 13, 2009
(86) PCT No.: PCT/IB09/50605

§ 371 Date: Aug. 12, 2010

(30) Foreign Application Priority Data
Feb. 13, 2008 (ES) 200800458

(51) Int. Cl. H04N 7/18

(52) U.S. Cl. 348/154

(57) ABSTRACT

System and method for monitoring the activity of a person within a compound, comprising at least two predefined areas, characterized in that the system comprises means for detecting a person within the first predefined area, to verify the presence of a person within the first predefined area, means for activating the sensor of the first predefined area, means for deactivating the sensor of the first predefined area, to verify if there is activity of the person within the first predefined area, to verify the presence of the person within the second predefined area, means for activating the sensor of the second predefined area, means for deactivating the sensor of the second predefined area, to verify if there is activity of the person within the second predefined area; means for starting a counter of a predetermined period of time and means for generating an inactivity person alarm.

The present invention relates to a method for monitoring the activity of a person within a compound, comprising at least two predefined areas, each one comprising at least one sensor. More specifically, the invention relates to a method for monitoring the activity of people in a multi-stage area, taking into account the different possible causes of false alarms, with the intent to avoid reporting them to a third person or equipment.

It also refers to a system for monitoring the activity of a person in a compound, being suitable to carry out said method.

### BACKGROUND OF THE INVENTION

As advances in health sciences increase, the aging of the population creates several problems in their care, and thus arises the need to help and care for older people more effectively. For this, there are currently known various systems of remote care of elderly people who, because of their reluctance to live in a nursing home or daytime center, choose to live at home without direct medical and caring staff. These systems are based on monitoring the activity of a person in an compound such as a house or a room, to control potential accidents or health problems the person may have.

Systems for monitoring the activity of older people can be differentiated between active and passive: active systems monitor physical activity and body of a person and detect any change in its normal life (such as alteration of vital signs, on-effort, fainting, etc. . . . ) and passive systems control devices weared by the person, notifying an alarm if, for example, the person is not using a device during a predetermined time.

However such systems are restricted to specific patient situations, such as falls to the ground (using height sensors) or specific states of an apparatus (such as telephone use), but do not combine both controls in a multi stage-area, and, above all, they have a high number of false alarms produced over the time they control people and equipment.

The document EP1585078 describes a system for monitoring the activity of a person in a room and for monitoring the entry and exit from the premises of that person. The system comprises a sensor to detect the presence of people in that area, and means to generate alarms based on information received by the sensors.

However, the system has the disadvantage that only applies to enclosures with a single predefined area; it does not contemplate the possibility that the compound comprises more than one predefined area and that the person can move from one area to another.

### SUMMARY OF THE INVENTION

From the above, it is an object of the present invention to provide a method for monitoring the activity of a person within a compound which comprises at least two predefined areas.

This object is achieved according to claim 1, providing a method for monitoring the activity of a person within a compound, comprising at least two predefined areas, each comprising at least one sensor, the method comprising the steps of:
a. Identifying the person within the first predefined area, from the corresponding sensor;
in case of positive result, performing the steps of:
   b. Activating the sensor of the second predefined area;
   c. Deactivating the sensor of the first predefined area;
   d. Starting a counting of a predetermined period of time;
   e. Verifying, before the end of the counting, the person's presence within the second predefined area, from the corresponding sensor;
   in case of positive result, performing the steps of:
      f. Activating the sensor of the first predefined area;
      g. Deactivating the sensor of the second predefined area;
      h. Starting a counting of a predetermined period of time;
      i. Verifying, before the end of the counting, the person's presence within the first predefined area, from the corresponding sensor;
      in case of positive result, the control of the method goes to step (b);
      in case of negative result, performing the steps of:
         j. Activating the sensor of the second predefined area;
         k. Verifying if there is activity of the person within the second predefined area;
         in case of positive result, the control of the method goes to step (g);
         in case of negative result, performing the steps of:
         l. Generating an inactivity alarm for the person;
   in case of negative result in step (e), executing the steps of:
      m. Activating the sensor of the first predefined area;
      n. Verifying if there is activity of the person within the first predefined area;
      in case of positive result, the control of the method goes to step (c);
      in case of negative result, performing the step of:
         o. Generating an inactivity alarm for the person.

This method is accomplished with the monitoring of the person in a room (e.g. their home) comprising at least two predefined areas such as two rooms, so the person can be monitored while changing from one room to another. It is clear that the method can be extended to a site with more than two predefined areas (e.g. three) and a monitoring performed similarly in all areas, each comprising at least one sensor.

Furthermore, by disabling the sensor of the area where the monitored person is, a significant energy saving in the system is achieved. If an area comprises more than one sensor and the presence of the person is detected in this area, all of the sensors can be disabled, thereby saving even more energy.

Furthermore, verification of the presence of stage (e) may comprise a presence verification, e.g. by means of sensing the presence or sensing the motion by means of, for example, a motion sensor, since both verifications can be used to know if the person is in the second predefined area.

Similarly, the verification of presence of the step (i) may comprise the same verification of presence or motion, since both are verifying if the person is, in this case, in the second predefined area.

Furthermore, steps (b) and (c) of the method can be executed in any order, since it is not necessary that the activation of the sensor of the second area and the deactivation of the sensor of the first area are made in a certain order, i.e., activation or deactivation of one of the sensors is not binding on the other sensor. The same applies for steps (f) and (g).

The predetermined period of time may depend on many factors, primarily on factors relating to the person to be monitored (e.g., the type of person to be monitored, their habits, or physical characteristics) that make that person should be monitored more or less frequently. For example, an elderly person may require a lower predetermined time, intending to detect as soon as possible any eventuality that might happen.

According to an embodiment of the invention, step (a) comprises a sub-step (a1) of verifying the presence of the person within the first predefined area, from a presence sensor.

According to another embodiment of the invention, step (a) comprises a sub-step (a2) of verifying the movement of the person within the first predefined area, from a motion sensor. That motion sensor can be, for example, an infrared sensor that detects movement of a person in the area covered by it.

According to an embodiment of the invention, step (k) comprises the sub-steps of:
k1. Obtaining at least one image of the second predefined area;
k2. Determining the status of the person from the obtained image;
k3. Creating a pattern of activity of the person from the determined situation;
k4. Comparing said pattern of activity with at least one predetermined pattern of activity.

Thus, by comparing the pattern obtained from the image in real time (i.e., captured in the moment in which the alarm is generated) with a predetermined pattern of positions that may suggest an indisposition of the person (a type of non-natural position of the person that may mean, for example, the person has fallen unconscious when he/she was sitting in a chair), it is possible to determine whether the person may have a health problem.

This pattern may be, for example, a silhouette of the person, created from the comparison between an image of the predefined area without people in it and a picture of the area with the person that can be compared to patterns in silhouettes denoting the possible causes of idle person alarm.

According to another embodiment of the invention, step (n) comprises the sub-steps of:
n1. Obtaining at least one image of the first predefined area;
n2. Determining the status of the person from the obtained image;
n3. Creating a pattern of activity of the person from the determined situation;
n4. Comparing said pattern of activity with at least one predetermined pattern of activity.

In another implementation, step (k) comprises sub-step (K11) of detecting the movement of the person within the second predefined area, from, for example, motion sensors, such as passive infrared sensors (PIR).

Thus, verifying the activity of the person in the second predefined area using two different elements (pictures/movements), redundant with each other, will result in fewer false alarms, ensuring proper monitoring of the activity of the person in an area.

Similarly, step (n) comprises the sub-step (n11) of detecting the movement of the person within the first predefined area.

According to an embodiment of the present invention, at least one of the predefined areas has assigned several parameters related to the behaviour of the person within that area. Thus, the behavior of individuals within each area can be taken into account to detect activity or no activity:
If the person is in, for example, a bedroom, he/she may be relatively inactive (sleeping or reading) or
If the person is in, for example, a kitchen, he/she may be cooking and may be moving more frequently than that.

Moreover, the method may comprise, in case of positive result in step (e), a step (p) of sending a control signal to inform about a detection of presence within the second predefined area, from the sensor of the second predefined area to the sensor of the first predefined area, for causing their activation.

Thus, the sensors transmit a warning to other sensors on the detection performed in the area: the sensors of its own area, to be disabled, and the sensor in other areas to be activated, thus controlling the change in the monitored area.

Moreover, the method may also comprise, in case of positive result in step (i), a step (q) of sending a control signal to inform about a detection of presence within the first predefined area, from the sensor of the first predefined area to the sensor of the second predefined area, for causing their activation.

According to another aspect of the invention, a system for monitoring the activity of a person within a compound comprising at least two predefined areas is provided, characterized in that the system comprises means for detecting a person within the first predefined area, means for verifying the person's presence within the first predefined area, means for activating the sensor of the first predefined area, means for deactivating the sensor of the first predefined area, means for verifying if there is activity of the person within the first predefined area, means of verifying the presence of the person within the second predefined area, means for activating the sensor of the second predefined area, means for deactivating the sensor of the second predefined area, means for verifying if there is activity of the person within the second predefined area; means for starting a counting of a predetermined period of time, and means for generating an inactivity alarm for that person.

According to an embodiment of the invention, the means for verifying if there is activity of the person within the first predefined area comprise height sensors for capturing the fall of a person.

Thus, if there is a sequence in which these sensors indicate a fall (as detected during consecutive moments of time, the person is on a greater height and then the person moves to a lower height) may be helpful, for example, alongside a picture of the area where the person is, an alarm to detect inactivity of a person due to his/her downfall.

According to another embodiment of the invention, and similarly to the case of the first area, the means for verifying if there is activity within the second predefined area comprise sensors to detect the fall of a person.

According to a preferred embodiment of the invention, the means for generating an alarm for inactivity of a person comprise means for sending an image of the predefined area in which the alarm has been generated.

According to another aspect of the invention, it is provided a sensor to detect a person in a predefined area comprising processing means for detecting a person and means for processing a control signal for the detection of a person in another predefined area.

Such means for processing a control signal can be arranged in one or more external modules, connected through, for example, a Wi-Fi or RF connection linked to the means to process the detection or within a module enclosed in the same sensor.

According to an embodiment of the invention, the means for processing the detection of a person comprise means to detect a person, means to deactivate the sensor from detecting and means for sending a control signal warning about the detection of a person.

According to an embodiment of the invention, the means for processing a control signal for the detection of a person in another area comprise preset means for receiving the control signal and means for activating the sensor from the received signal.

According to another aspect, the invention provides a computer program comprising program instructions that run on a computer system to perform the method for monitoring the activity of a person within a compound.

This computer program can be stored in physical storage media, such as a recording media, a computer memory or a read-only memory, or can be transported by a carrier wave, such as electrical or optical one.

### BRIEF DESCRIPTION OF DRAWINGS

For a further understanding of the above, the accompanying drawings are provided, wherein schematically and only by way of non-limitative example, there are represented practical implementations of the present invention.

In the drawings,

FIG. 1 shows a diagram block of the system for monitoring the activity of a person within a compound, according to the invention;

FIG. 2 shows a schematic representation of a plant view in a compound in which the system according to FIG. 1 is applied;

FIG. 3 shows a second schematic representation of a plant view of a compound;

FIG. 4 is a graphical representation of a state diagram showing different states of a sensor that is used in the system of FIG. 1;

FIG. 5 is a graphical representation relating to states of a sensor over time;

FIG. 6 is a flowchart of the method to monitor the activity of a person within a compound, according to the invention.

### DESCRIPTION OF A PREFERRED EMBODIMENT OF THE INVENTION

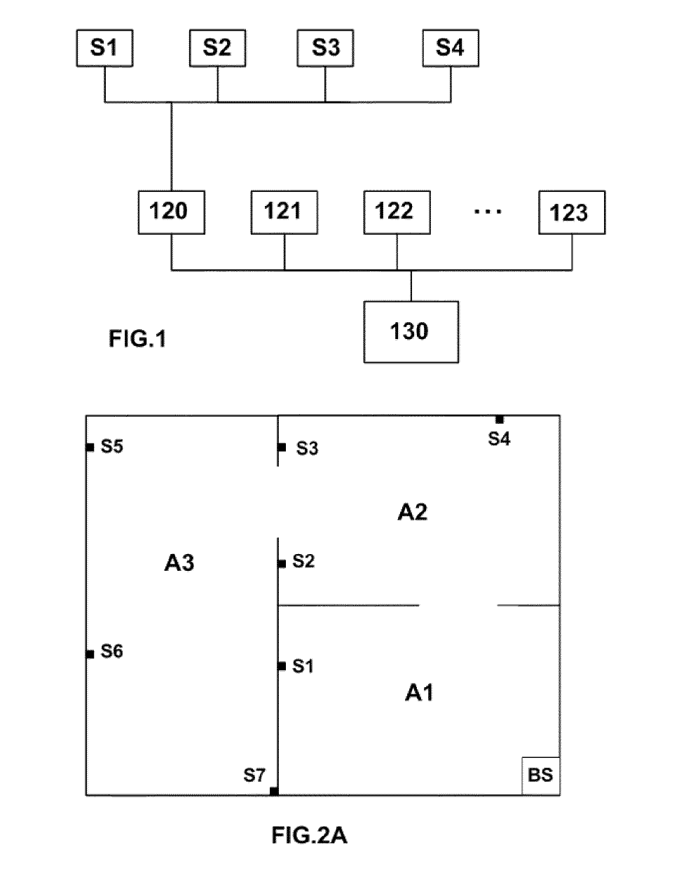

As can be seen in FIG. 1, the system for monitoring the activity of a person comprises means for verifying the presence of the person within a predefined area, more specifically, sensors S1, S2, S3, S4, S5, S6 and S7 connected to a first base-station 120. The sensors are sensing the presence and movement. In addition, the base-station 120 in turn is connected to a central server 130, which can be connected to other base-stations 121, 122, 123 which comprise more sensors (not represented in the figure). Through this connection, the data obtained by different sensors S1, S2, S3 and S4 is transmitted to the first base-station 120 through a wireless communications network, such as an RF network, and through other wireless network communications, all data obtained from different sensors is transmitted to the central server 130. This data transmission between the base-station 120 and the central server 130 can be made via the Internet.

These sensors can be powered by batteries, preferably by ensuring a greater autonomy than usual through the energy savings involved in the method for monitoring a person within a compound according to the present invention, the preferred implementation described below. In addition, these batteries can be powered by solar cells, thus ensuring a longer life.

In addition, the sensors comprise means for verifying the presence of the person in various other areas to which it is located. This is done through the means for transmitting data from all sensors, so that a sensor can distinguish between whether the sensors transmit data from the same area or from different areas of the sensors. When a sensor transmits data it is detected in its area. Therefore, if a sensor identifies a first data transmission from a second sensor located in an area other than its own area, this means that the second sensor detects presence in its area, and the first sensor can verify presence detection in the area of second sensor.

Moreover, the central server comprises means for detecting if the monitored person leaves the property where the predefined area is, said means comprising a sensor for detecting opening and closing doors. This way, when the system detects that the person has left the building, certain sensors of the predefined area can be left in a stand-by state to save energy. Departure and arrival times can also be recorded, to use such information in the recognition of changes in habit of the individual, as will be explained in detail below.

In addition, the central server comprises means for verifying the activity of a person within a predefined area, which are a particular form of recognition of activity in which it verifies if there is activity, and if it does not exist, if the inactivity is a cause of alarm or not. Because of this, when inactivity is detected to verify whether or not there is activity, the module takes into account various parameters, including:
Default time during which it is normal that there is no activity (time in which the person usually sleeps or rests);
The person is moving too slowly, avoiding detection sensors. This may be the case in which the person is reading, watching television, holding a conversation with another person, etc.
The person is inactive due to a physical problem.

First, the recognition module can set schedules during which no account is taken of a possible inactivity alarm, as the daily habits of the person during those periods of time are considered idle.

In this way the system is also able to monitor changes in the habits of the person, through an expert system for recognizing patterns within the recognition module, which, based on information collected on the habits of the person, detects changes in them, and can create an alarm in the system.

This allows to anticipate problems in the person, as indicators of changes in habit emerging problems, such as illness, depression, etc. which if not detected in the primary states, then can be very costly to fix them later. You can also enter the expert system about the habits of the person known in advance.

In the other two situations to be considered when detecting inactivity, the recognition module verifies inactivity using a webcam installed in the area of the sensor that detects any alarm. Normally, the camera covers the same range as the sensor to obtain an image of the entire area monitored by the sensor. This camera is equipped with vision algorithms used to detect both the intrusion of a person, or in this case, the inactivity of a person.

Besides the methods for verifying the activity of a person, a method of comparing images of the predefined area can also be used, comparing a sequence of two or more consecutive images among them in time, so detecting differences between each movement can be detected without the need to activate, for example, a video recording of the predefined area.

On the other hand, if the activity recognition module verifies that it is actually being given an alarm situation in some of the areas monitored by the system, the system comprises means for transmitting alarms. Such means may be such as sending voice messages, SMS, MMS or e-mail messages to default addresses belonging to a supervisor, to a medical care organization or to the fire brigade, etc. The person receiving the alarm, can request additional information on the situation regarding the specific alarm (details on the type of alarm, the time spent idle, when you came home, etc.) that may be useful to place the receiver of the message in the context of the alarm detection.

The recognition module also includes means for recognizing whether the person has entered or left the premises where the predefined areas are, and means for generating a notification of arrival of the person to that site. This warning signal can be transmitted in the same way as that one of the alarms described above.

In addition, sending of alarms or announcements can be made through any mobile or fixed wireless network known in the prior art, adapting in each case the delivery according to the characteristics of that particular network.

The system also includes means for controlling access to the monitored areas, such as the doors to rooms or property that is monitored. This will ensure that emergency personnel to assist the person, after receiving the alarm, can gain access to the property without the person being monitored having to manually open the door of the building. Thus, through the alarms and through the control of the access to the predefined areas, the person will receive care in a short time, possibly preventing greater injuries.

The equipment can also use wireless technology to, for example, allow a warden, by means of a radio transmitter, to remotely open the door of the area, if he can not get there in time, allowing another person closer to the building, but without access to it, to assist the affected person.

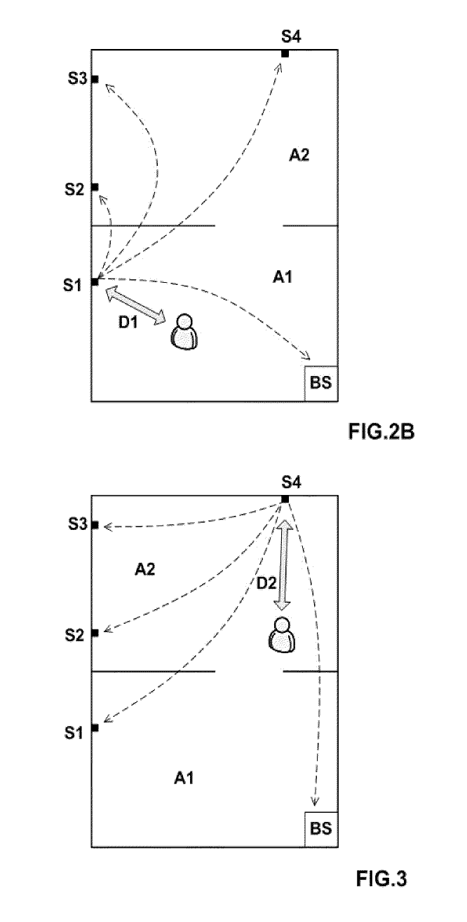

This embodiment of the invention includes a method for monitoring a person within a compound, according to the present invention, which will be described below from FIGS. 2A, 2B, 3 and 4.

In FIGS. 2A, 2B and 3 a diagram is shown of the system for monitoring the activity of a person in a compound which comprises three predefined areas A1, A2 and A3, which include a set of sensors S1, S2, S3, S4, S5 , S6 and S7, located within these areas. The sensors transmit signals by radio-frequency in predetermined frequency ranges, so monitoring those frequencies, it can be detected if a sensor is transmitting data or it is inactive. In the area A1 it is also placed a base station BS which collects data from all sensors and communicates with them by sending control signals and recording the status of all system elements.

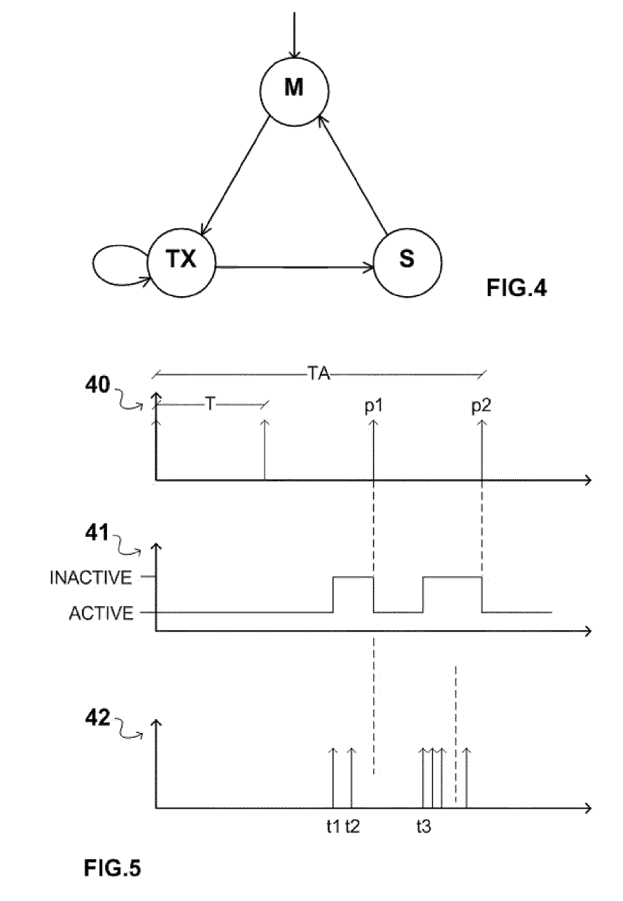

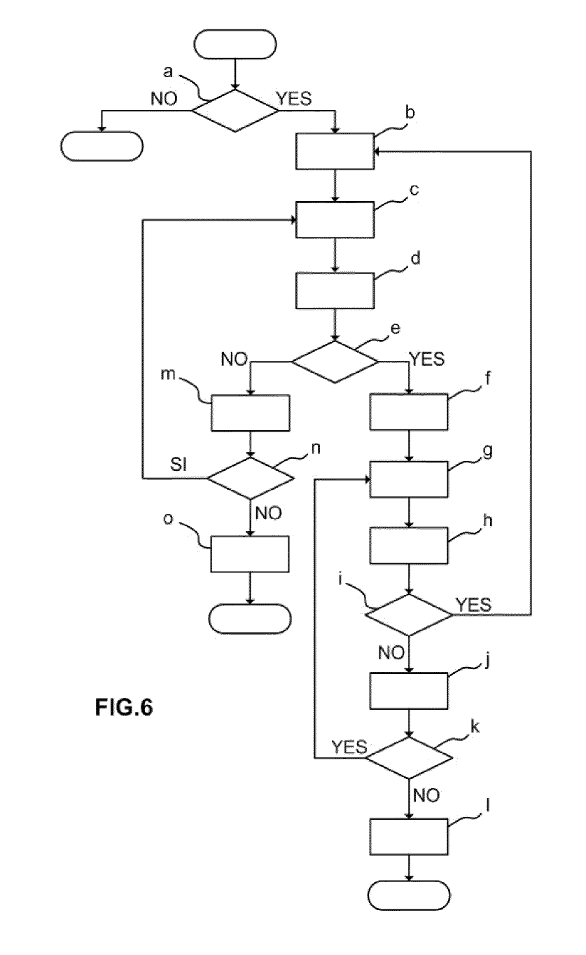

By FIGS. 2B, 3 and with the help of FIG. 4 an example of a situation will be described, where the person is detected in the area A1, and at one point in time, moves to the area A2.

FIG. 4 represents a diagram of states corresponding to the sensor S1. In this diagram, in an initial state, the sensor S1 is active (status monitoring M), and only leaves the M state to the transmission state (TX) under the condition that the presence of a person is being detected. In the state TX, the transmission of a broadcast type message is being done, which reaches the other sensors of the system and the base station BS. The time at which presence is detected, D1, and a presence message that is being transmitted, can be seen in FIG. 2, where also can be seen that following the presence detection D1, sensor S1 sends a presence message to all the other sensors and to the base station BS (in the TX state sensor S1).

Then, when the sensor receives a message of acknowledgment (Acknowledge message, ACK) from the base station BS, it starts a counting period TA and enters the state S (stand-by state in FIG. 4) in which the sensor is idle. This means that the sensor ignores any detected presences and does not respond to them.

In this state, the sensor goes back to the M state if the presence of the person is detected in another room, or if the end of the counting period TA is reached, or if a signal indicating the end of the period T is received. These conditions and signals will be explained in more detail below.

If during the counting period of TA, sensor S1 detects the transmission of data over the frequency ranges used by, for example, S4, this means that S4 has detected the presence of the person (D2 in FIG. 3), which has entered into the predefined area A2, where they are sensors S2, S3 and S4. Then, as shown in FIG. 3, the sensor S1 receives the data transmission (in this case initiated by S4) and it gets active (it comes back to he monitoring state M). At the same time, the sensors S2 and S3 receive the same transmission, and because they are in the same area A2 as the sensor S4 that has detected presence, they are deactivated themselves, just as S4.

The second condition that makes S1 switch from the S state to the M state (monitoring state) is to receive a pulse signal indicating the end of period T. This signal period T is used to change the state of the sensor, so it monitors presence more frequently, and in case it does not find activity, to generate an alarm.

The last condition to switch from state S1 to state M is to receive a pulse of the period signal TA. This period signal TA is used to directly activate an alarm, in case that between pulses of the same signal it is not detected activity in the predefined area, nor activity in other areas, nor are situations of false alarm.

In this way, according to the person being monitored and the room you're in, you can compute the time TA considering that it is the maximum time during which inactivity is allowed under any circumstances. The counting of TA is never restarted, and hence it is a constant signal that only generates an alarm if between two pulses of the period signal TA, there has not been detected any activity.

The system allows you to change the duration of TA for different situations, but for its proper functioning, a relationship between TA and the time period T should exist, which according to this embodiment is T=TA/4.

Another possible scenario in the example above would be that the person, after having moved to the area A2, moves again to the area A3, where the S5 sensor would detect its presence, and would send a broadcast message to all sensors and would deactivate itself, similarly to the case where the person moves from the area A1 to the area A2. In addition, therefore, when receiving the broadcast message, the other sensors of the area A3 (S6 and S7) would deactivate themselves, and all other sensors would be activated in order to detect a possible movement of the individual from the A3 area to any other area.

This example shows that a multi area building or compound can be monitored with one or more sensors arranged in each predefined area, by the use of the method of this invention, and regardless of the number of areas covered by the system, or the number of sensors within the system, as long as each area to monitor has at least one sensor that covers it.

By the described method it is achieved, firstly, an energy saving when monitoring the activity of a person through a multi-control area. When detecting the presence of a person in an area, a sensor notifies the other sensors of that detection and it turns off for some time, saving energy. Then, the remaining sensors in the same area are also turned off, saving energy, and sensors placed in other areas of the house are activated to detect if the person moves from one area to another.

FIG. 5 shows, for example, a graph on the states of a sensor, in this case, the sensor S1. In the figure in the timeline labelled as 40, there are the time periods T and TA: TA is the time counting period during which sensor S1 is active, and over which if S1 has not identified presence, at the end of the counting, several conditions are verified, and, if negative, an inactivity alarm is being generated. In this embodiment the T period is one quarter of TA.

The timeline labelled as 41, depicts the state of the sensor S1 through time, having two possible states: active, i.e. the state in which the sensor is monitoring the presence of a person in the predefined area A1, and inactive or stand-by, where the sensor ignores the presence signals that may arrive.

The timeline labelled as 42, shows the presence signals of the person being monitored, detected by the sensor in the area A1.

As shown by the timelines, at the beginning, sensor S1 is active, until it detects the presence of a person within the area A1 at time t1. Then the sensor deactivates itself and ignores a second presence signal at the instant t2, until the P1 end of period signal, corresponding to the end of the T period, is received, where the sensor changes it's state back to active state. At the time it returns to the active state, the sensor waits until it receives a new presence signal at the instant t3, at which point it deactivates itself again, and again it ignores the next presence signals until after it receives the P2 end of period signal, corresponding to the end of the next T period, which re-activates the sensor which begins monitoring again.

At each moment that the sensor S1 changes from active to inactive status, in parallel to its deactivation, it transmits presence data to all the other sensors, and to the base station. Thus, the sensors that cover areas other than their own may, upon receiving this information, activate and monitor the presence in their respective areas, with the aim of detecting a change of room. Moreover, as long as S1 is deactivated, it notes the transmission of data in the frequency ranges used by the base station and the other sensors located in areas different from its own, used to transmit data, with the purpose of changing its own state to active when a sensor detects the presence in their area. Also, S1 observes all the time the data transmission in the frequency ranges of the other sensors that cover the same area as itself to deactivate in case one of them detects a presence before him, so that it saves energy. In addition, the sensor must be in contact with at least one BS to, for example, react to commands transmitted from that BS.

In this preferred implementation, the TA period is transmitted to the sensor as a digital message that includes the codified length of the period, allowing the sensor to adjust the length of the counting to the received value and, if the sensor is inactive, it is activated at the end of the period TA. In this way, by sending a message to the sensor with the length of the TA period, at the beginning of each TA period, from the base station to the sensor, if a message is lost, the sensor also changes its state, because it uses the counting of the previous received message. Also, when the sensor receives the next message after the lost message, the sensor will know that it has to start counting with the time it has just received at that moment. Where several consecutive messages are lost, the sensor will use by default the value of the last TA period received.

Although we have been describing and representing particular implementations of the present invention, it is clear that the person skilled in the art may introduce variants and modifications, or replace some details by other technically equivalent, without departing from the scope of protection defined by the claims attached.

Despite the fact that the described implementations of the invention with reference to the drawings also comprise computer systems and processes in computing systems, the invention also extends to computer programs, particularly computer programs on or in a carrying media adapted to the invention into practice. The computer program can be in the form of source code, object code or an intermediate code between source code and object code such as a partially compiled form, or any other form suitable for use in the implementation of the processes covered with the invention. The carrying media can be any entity or device able of store the program.

For example, the carrying media may comprise storage medium such as a ROM, for example a CD ROM or a semiconductor ROM, or a magnetic recording medium, such as a floppy disc or hard drive. In addition, the carrying media may be a transmissible carrier such as an electrical or optical signal that can be transmitted via electrical or optical cable or by radio or other means.

When the computer program is contained in a signal that can be transmitted directly through a cable or other device or means, the carrier may be constituted by such cable or other device or medium.

Alternatively, the carrying media may be an integrated circuit where it is encapsulated (embedded) the computer program, such integrated circuit being adapted to perform, or to be used to conduct the relevant processes.

1. A method for monitoring the activity of a person within a compound, comprising at least two predefined areas, each comprising at least one sensor, the method comprising the following steps:
a. Identifying the person within the first predefined area, from the corresponding sensor;
in case of positive result, performing the steps of:
b. Activating the sensor of the second predefined area;
c. Deactivating the sensor of the first predefined area;
d. Starting a counting of a predetermined period of time;
e. Verifying, before the end of the counting, the person's presence within the second predefined area, from the corresponding sensor;
in case of positive result, performing the steps of:
f. Activating the sensor of the first predefined area;
g. Deactivating the sensor of the second predefined area;
h. Starting a counting of a predetermined period of time;
i. Verifying, before the end of the counting, the person's presence within the first predefined area, from the corresponding sensor;
in case of positive result, the control of the method goes to step (b);
in case of negative result, performing the steps of:
j. Activating the sensor of the second predefined area;
k. Verifying if there is activity of the person within the second predefined area;
in case of positive result, the control of the method goes to step (g);
in case of negative result, performing the steps of:
l. Generating an inactivity alarm for the person;
in case of negative result in step (e), executing the steps of:
m. Activating the sensor of the first predefined area;
n. Verifying if there is activity of the person within the first predefined area;
in case of positive result, the control of the method goes to step (c);
in case of negative result, performing the step of:
o. Generating an inactivity alarm for the person.

2. A method according to claim 1, wherein step (a) comprises a sub-step (a1) of verifying the presence of the person within the first predefined area, from a presence sensor.

3. A method according to claim 1, wherein step (a) comprises a sub-step (a2) of verifying the movement of the person within the first predefined area, from a motion sensor.

4. A method according to claim 1, wherein step (k) comprises the sub-steps of:
k1 . Obtaining at least one image of the second predefined area;
k2. Determining the status of the person from the obtained image;
k3. Creating a pattern of activity of the person from the determined situation;
k4. Comparing said pattern of activity with at least one predetermined pattern of activity.

5. A method according to claim 1, wherein step (n) comprises the sub-steps of:
n1. Obtaining at least one image of the first predefined area;
n2. Determining the status of the person from the obtained image;
n3. Creating a pattern of activity of the person from the determined situation;
n4. Comparing said pattern of activity with at least one predetermined pattern of activity.

6. A method according to claim 1, wherein step (k) comprises sub-step (K11) of detecting the movement of the person within the second predefined area.

7. A method according to claim 1, wherein step (n) comprises the sub-step (n11) of detecting the movement of the person within the first predefined area.

8. A method according to claim 1, wherein at least one of the predefined areas has assigned several parameters related to the behaviour of the person within that area.

9. A method according to claim 1, further comprising, in case of positive result in step (e), a step (p) of sending a control signal to inform about a detection of presence within the second predefined area, from the sensor of the second predefined area to the sensor of the first predefined area, for causing their activation.

10. A method according to claim 1, further comprising, in case of positive result in step (i), a step (q) of sending a control signal to inform about a detection of presence within the first predefined area, from the sensor of the first predefined area to the sensor of the second predefined area, for causing their activation.

11. A system for monitoring the activity of a person within a compound, comprising at least two predefined areas, characterized by the fact that the system comprises means for detecting a person within the first predefined area, means for verifying the person's presence within the first predefined area, means for activating the sensor of the first predefined area, means for deactivating the sensor of the first predefined area, means for verifying if there is activity of the person within the first predefined area, means of verifying the presence of the person within the second predefined area, means for activating the sensor of the second predefined area, means for deactivating the sensor of the second predefined area, means for verifying if there is activity of the person within the second predefined area; means for starting a counting of a predetermined period of time, and means for generating an inactivity alarm for that person.

12. A system according to claim 11, characterized by the fact that the means for verifying if there is activity of the person within the first predefined area comprise height sensors for capturing the fall of a person.

13. A system according to claim 11, characterized by the fact that the means to verify whether there is activity of the person in the second predefined area comprise height sensors to capture the fall of a person.

14. A system according to claim 11, characterized by the fact that the means for generating an inactivity alarm for a person comprise means for sending an image of the predefined area in which the alarm is generated.

15. A sensor for detecting a person within a predefined area comprising processing means for detecting a person and means for processing a control signal corresponding to the detection of a person within a different predefined area.

16. A sensor according to claim 15, characterized by the fact that the means for processing the detection of a person comprise means for detecting a person, means for deactivating the sensor when a person is detected, and means for sending a control signal to inform about a detection of presence of a person.

17. A sensor according to claim 15, characterized by the fact that the means for processing a control signal for the detection of a person in another area comprise means for receiving the control signal and means to activate the sensor from the control signal.

18. A computer program comprising program instructions for causing a computer system to perform the method according to claim 1.

19. A computer program according to claim 18, characterized in that it is stored in a recording media.

20. A computer program according to claim 18, characterized in that it is carried by a carrier signal.
